(19) United States
(12) Patent Application Publication
(10) Pub. No.: US 2015/0302895 A1
(43) Pub. Date: Oct. 22, 2015

(54) DVD-BLU RAY DISC ELECTRONIC STORAGE DEVICE

(71) Applicant: Stephen M. Sala, Wall, NJ (US)

(72) Inventor: Stephen M. Sala, Wall, NJ (US)

(21) Appl. No.: 14/257,172

(22) Filed: Apr. 21, 2014

(51) Int. Cl. G11B 27/034; H04N 5/775; H04N 5/76

(52) U.S. Cl. CPC G11B 27/034; H04N 5/7605; H04N 5/775

(57) ABSTRACT

An electronic storage device for saving movies of DVD, Blu-ray and movie files into a library of movies by allowing the stripping of non-desired information content from embedded information processing.

### CROSS-REFERENCE TO RELATED APPLICATIONS

A Provisional Patent Application covering the invention described herein was filed on Aug. 28, 2013, and assigned Ser. No. 61/959,570.

### STATEMENT REGARDING FEDERALLY SPONSORED RESEARCH OR DEVELOPMENT

Research and development of this invention and Application have not been federally sponsored, and no rights are given under any Federal program.

### REFERENCE TO A MICROFICHE APPENDIX

NOT APPLICABLE

### BACKGROUND OF THE INVENTION

1. Field of the Invention

This invention relates to the electronic storage of movies and like content, in general, and to an electric storage device for use capable of recording such items on a digital video disc and Blue-Ray Disc into a library, and which can then be viewed on a television screen for subsequent playback, in particular.

2. Description of the Related Art

Years ago, once the lights were turned down in a movie theater, a motion picture began to play on the screen for the audience. Over time, the process changed so that the movie was preceded by a series of preview attractions—for the benefit of the theater operator in an attempt to promote future patronage, whether the audience was interested in those types of films to be presented or not. Then, over time, even the “previews” were preceded—first by promotions to visit the snack bar, then by commercial advertising of national products and services, and then to the point where today even advertisements of local businesses are shown first. The situation advanced to the point where now, although a movie may be listed on-line or in the press to begin at a certain time, it is rare for the motion picture to begin playing until 15-20 minutes of these type presentations have gone forward. This, of course, produces great amounts of consternation for those trying to get to the theater before the listed time, and/or making arrangements to meet others or arrive at following destinations at expected intervals after the film has run its advertised 1½ to 2½ hours as promoted.

With today's technology, similar “progress” has invaded the home-viewing environment. With past video cassette players, for example, the tape would begin essentially immediately. Modifications for digital video discs and for Blu-Ray discs in today's manufacture, however, have incorporated all the included material undesirably included in the moving picture showing industry—except, perhaps, for visiting the snack bar or for local business advertising. In fact, some present technologies even go so far as to prevent a viewer's advancing of the disc from one track to a later one, or for fast-forwarding through each track in turn in order to reach the play content desired to be viewed. The degree of agitation that oftentimes results only increases exponentially where a viewer, finally reaching the film content on the disc, then decides that it is not something that he/she wishes to continue watching—and proceeds by ejecting the disc and inserting its replacement, only having to watch through similar previews before the content information is reached.

### OBJECTS OF THE INVENTION

It is an object of the present invention, therefore, to provide an electronic storage device for home use capable of saving movies and like content on a digital video disc and Blue-Ray disc into a library, and which can then be viewed on a television screen for subsequent playback without all this disconcerting prerecorded, preview material.

It is an object of the present invention, also, to provide this electronic storage disc for subsequent viewing of the movie or like content on a computer screen.

It is another object of the invention to provide this type of electronic storage device which can play and rip these digital video discs and Blu-Ray discs for transfer to a hard-drive through the use of HDMI, USB port and Ethernet connections so as to allow purchase or rental of the disc from websites and for its movie content to be likewise stored without any previously inserted, undesired, fluff.

It is a further object of the invention to provide such an electronic storage device with an appropriate menu, “fast forward”, “rewind”, “pause” and like features as are typically found on today's DVD and video cassette players commonly present in a user's home.

It is yet another object of the invention to provide such an electronic storage device operable with standard infrared remote control units in carrying out the features of the invention of home disc storage as a form of video-pod, analogous to that for audio and photographic storage.

### SUMMARY OF THE INVENTION

As will become clear from the following description, the electronic storage device of the invention would allow its user to play the digital video disc or Blue-Ray disc as purchased to begin with. If the user enjoys the picture content, it can then be transferred to one or more mass storage devices of the unit without all, or any part of, the preceding “previews” or “commercial advertising” content. Once the picture content is so transferred to the mass storage device, then it can be viewed over and over again by merely selecting it from the movie library thus created.

### BRIEF DESCRIPTION OF THE DRAWINGS

These and other features of the invention will be more clearly understood from a consideration of the following description, taken in connection with the accompanying Drawings in which:

FIGS. 1, 2 and 3 are front, back and perspective views of a preferred embodiment of the electronic storage device of the invention;

FIGS. 4 and 5 are right and left side views of the electronic storage device;

FIGS. 6 and 7 are exterior and interior top views of the electronic storage device;

FIG. 8 illustrate function buttons for operating the electronic storage device—with the understanding that a remote control device is to be used in conjunction to provide a system with such features as power, eject, play, stop, pause, forward, rewind, zoom, and like modifiers of operation typically found on remote control units for DVD and Blue-Ray disc players and recorders; and

FIG. 9 illustrates terminal connections for operating the electronic storage device of the invention.

### DETAILED DESCRIPTION OF THE INVENTION

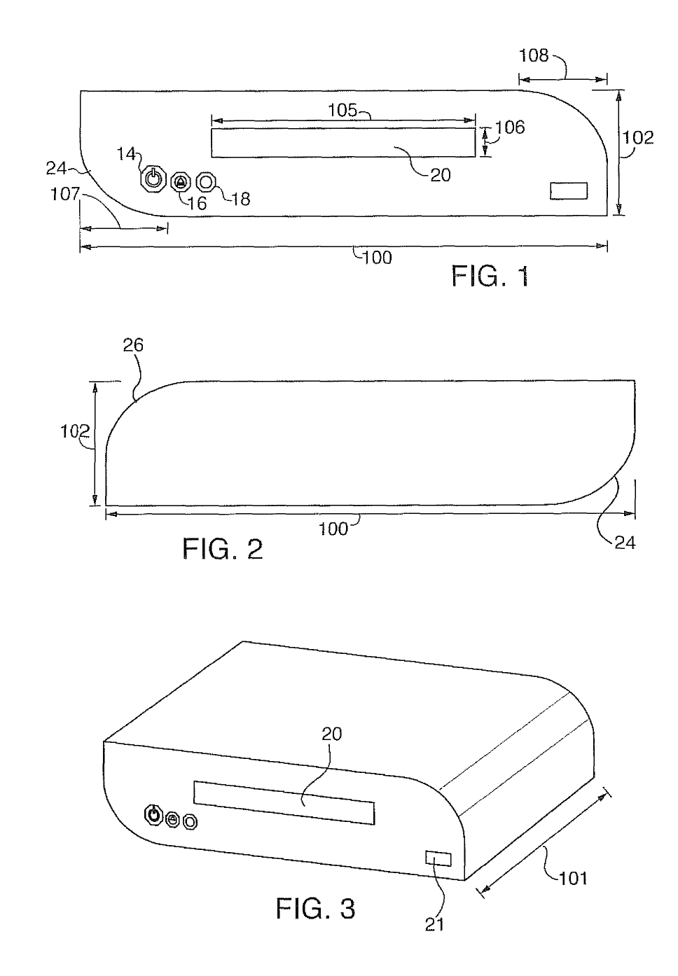

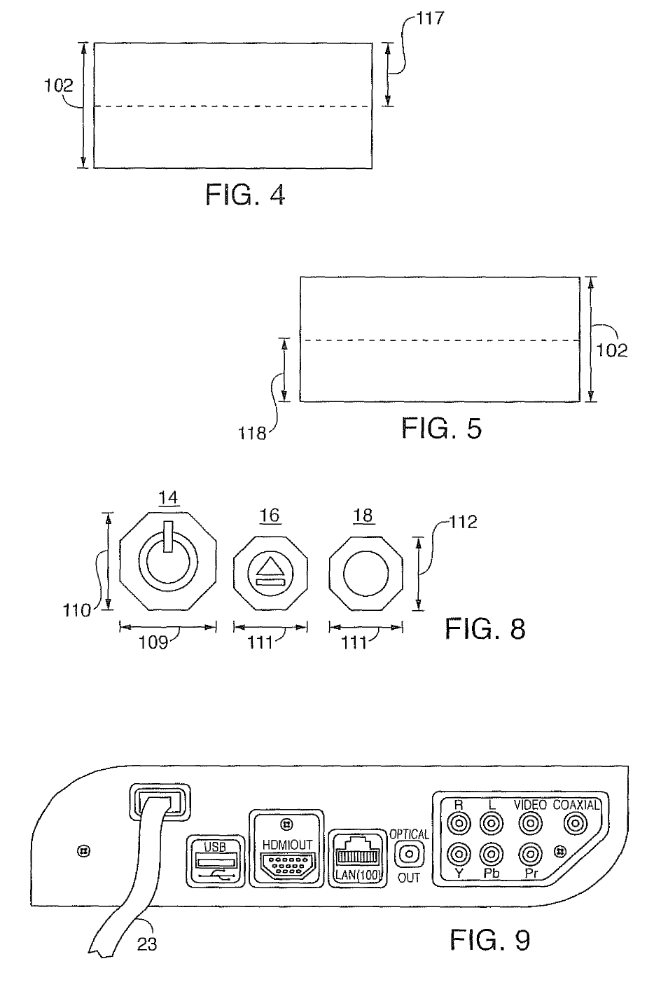

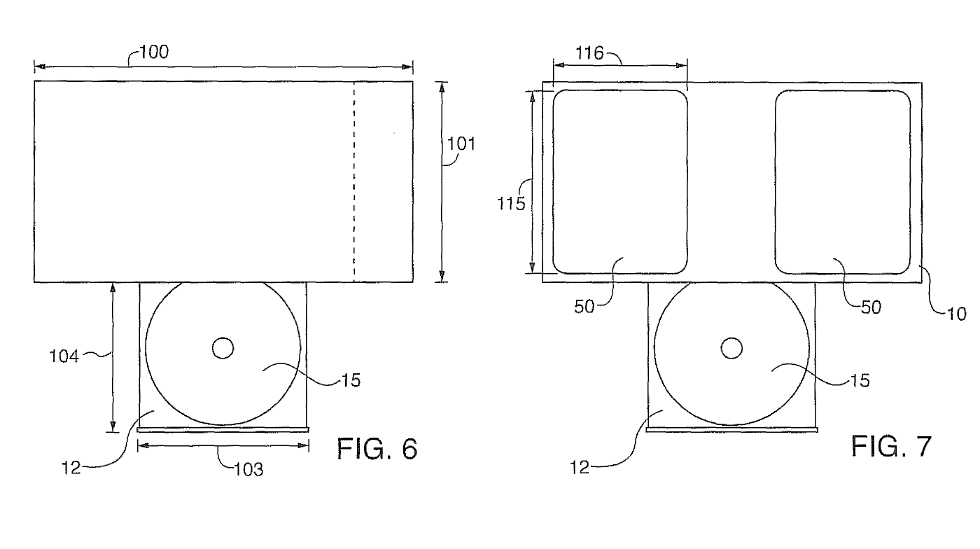

FIG. 7 shows a hard drive mass storage unit 50 for the electronic storage device 10 and an openable/closable tray 12 for a DVD and Blu-Ray disc 15, also shown in FIG. 6. A “power”, “open-close tray”, and “transfer disc” content control for the storage device 10 are shown as 14, 16 and 18 respectively, in each of FIGS. 1 and 8. The electronic storage device 10 may be of a length 100 of some 12 inches (FIGS. 1 and 2), a depth 101 of some 8½ inches (FIGS. 3, 6 and 7) and a height 102 of some 3 inches (FIGS. 1 and 2). The openable/closable tray 12 for the DVD and Blu-Ray Disc 15 may be of a width 103 of 5¼ inches (shown in FIG. 6, and of a depth 104 of some 5½ inches). The opening for the receipt of the tray 12 is shown at 20 in FIGS. 1 and 3, with a length 105 of some 5 inches and a height 106 of some ½ inch. As the front view of FIG. 1 and the back view of FIG. 2 illustrate, the lower left end 24 and the upper right end 26 of the electronic device 10 are shown curvilinear in providing a contour shape of 3 inch length at the lower left end and upper right end of the device—as illustrated at 107, 108 in FIG. 1. The “power” control 14 shown in FIGS. 1 and 8 as fed by the power cord 23 of FIG. 9 may preferably be ½ inch on a side (as at 109, 110), while the “open-close tray” control and “transfer disc” control 16 and 18 may each be of ⅜ inch length on a side, as shown at 111 and 112 in FIGS. 1 and 8. As will be appreciated by those skilled in the art, however, such dimensionings 100-112 are shown for a preferred construction in the various views of the drawings as constructed, and may be modified in accordance with any desired dimensionings that might be selected instead. As will also be recognized, the size of the hard drive mass storage unit 50 will depend upon how many disc contents can be stored, and how compressed the movie files or like content are to be selected. The dimensionings 115-116 in FIG. 7 are thus identified by question marks for adequate determination by a manufacturer of the electronic storage device 10. The sides of the electronic storage device 10 may similarly be designed to a straight 1½ inch length joined with a contoured 1½ inch length as illustrated at 117 and 118 in FIGS. 4 and 5. In this respect, infrared remote control operation of the storage device 10 is accomplished via the infrared receiver 21 in FIG. 3.

In operation, with the storage device 10 turned “ON”, with the disc 15 starting to play after the preview and advertising materials have been viewed, all that becomes necessary is for a user to activate the transfer to the hard drive mass storage unit 50 by depressing the transfer disc button 18. This, then, allows selective control over what is to be stored on the hard drive so that future viewing would be devoid of all or however much of the irritating preview material was added to the disc beforehand by the distributor. Once so stored, an appropriate menu on the electronic storage device can be viewed on a television screen or computer screen to which the electronic storage device is connected so that only the “transferred material” would then be viewable. In essence, a manner is described for stripping the objectionable preliminary material from the initial disc so that the desired message content can be thereafter viewed by the user in the comfort of his/her home without having to sit through, and watch, that material which was not at all desired when the disc purchase was made.

In other words, the storage device of the invention can be turned “ON” and “OFF” by its remote controller or by the power button 14 on the front of the device. The device will then turn “ON” and a menu screen appears as is conventional. On the menu screen, a series of multiple icons will be displayed.

In particular, a first, library icon brings the viewer to the DVDs and Blu-Rays that were previously ripped to the hard drive 116 of the storage device 10. As will be appreciated, those DVDs and Blu-Rays are stored in alphabetical order. Once a movie stored on the hard drive is selected for watching, all of the regular functions can be used—such as play, fast forward, rewind, pause, and stop.

Also, an internet icon enables the viewer to browse the Internet and purchase movies directly from various movie purchasing websites for storage on the hard drive, and thereby displayed on the menu screen. The movies purchased from the Internet in this manner are transferred to the library where the other ripped movies are located, in a manner well known.

At the same time, furthermore, the electronic storage device 10 can act as regular DVD or Blu-Ray player, as will be appreciated. There, if someone wishes to watch a movie before transferring it to another player, they will be able to do so. A “player-movie” icon to play a DVD or Blu-Ray would then also be displayed on the menu screen. If selected, the DVD or Blu-Ray disc will play and then all of the regular functions can be selected in the above manner—i.e., play, fast-forward, rewind, pause and stop.

Lastly, a further icon would be displayed, to rip the DVD or Blu-Ray to the storage. When the DVD or Blu-Ray is in the device and this icon chosen, the device will rip the disc to the unit's hard drive 116. The progress of the DVD or Blu-Ray being ripped is shown on the screen in conventional form, and when complete, the screen will indicate that the rip has been accomplished. After the DVD or Blu-Ray has been ripped, the movie identification is located in the player's library. Once the disc is so ripped to the hard drive, it can then be ejected by pressing the open/close button on the remote controller or on the front of the electronic storage device of the invention.

While there has been described what is considered to be a preferred embodiment of the present invention, it will be further appreciated by those skilled in the art that modifications can be made without departing from the scope of the teachings herein. For at least such reason, therefore, resort should be had to the claims appended hereto for a true understanding of the scope of the invention.

I claim:

1. An electronic storage device comprising:
an openable/closable tray dimensioned to receive one of a digital video and Blu-ray disc;
first means for supplying electrical power to activate said storage device to play any disc present within said openable/closable tray when closed;
second means for providing a first composite video and audio output signal of information content embedded on said disc;
a hard drive mass storage unit;
third means for transferring selected portions of said first composite video and audio output signals from said disc to said hard drive mass storage unit; and
fourth means for providing a second composite video and audio output signal of said selected portions of said first composite video and audio output signals transferred to said hard drive storage unit.

2. The electronic storage device of claim 1, wherein said fourth means provides a second composite video and audio output signal of substantially only said selected portions of said first composite video and audio output signal transferred to said hard drive mass storage unit.

3. The electronic storage device of claim 2, wherein said hard drive mass storage unit is of a capacity to store a plurality of composite video and audio output signals depending upon a predetermined compression selection for the embedded information content on a digital video or blu-ray disc within said closed tray.

4. The electronic storage device of claim 3, wherein said first means includes means for remotely supplying electrical power to said electronic storage device to play said disc.

5. The electronic storage device of claim 4, wherein said fourth means provides said second composite video and audio output signal to one of a television screen or computer screen for the viewing thereof.
